(19) United States
(12) Patent Application Publication
(10) Pub. No.: US 2011/0191321 A1
(43) Pub. Date: Aug. 4, 2011

(54) CONTEXTUAL DISPLAY ADVERTISEMENTS FOR A WEBPAGE

(75) Inventors: KRISHNA GADE, REDMOND, WA (US); ANDREY YEGOROV, REDMOND, WA (US); JOANNA CHAN, REDWOOD CITY, CA (US); DANIEL C. FAIN, REDMOND, WA (US); SANAZ AHARI, BELLEVUE, WA (US); NITIN AGRAWAL, REDMOND, WA (US)

(73) Assignee: MICROSOFT CORPORATION, Redmond, WA (US)

(21) Appl. No.: 12/698,115

(22) Filed: Feb. 1, 2010

(51) Int. Cl. G06F 3/048; G06F 17/30; G06F 3/14; G06F 12/08

(52) U.S. Cl. 707/709; 715/760; 715/205; 707/769; 711/118; 707/E17.014; 707/E17.108; 711/E12.017

(57) ABSTRACT

Embodiments of the invention disclose an advertisement or segment of a webpage that displays suggested search queries as selectable links. Suggested queries may be based on content associated with the webpage, or the description of the webpage (such as a URL), or default suggestions. In one example, content of a page is crawled for terms that are mapped to suggested queries. Queries may be represented as textual links or multimedia images embedded in pages accessed over a network, and selection of a query may direct or enhance search engine traffic.

### BACKGROUND

Advertising images embedded on a webpage may not relate to the content currently displayed on the webpage. The advertisements may offer one selection that leads directly to sponsored content. In some cases, selectable images that are displayed alongside web content lead to dead-end or biased sources, instead of providing or enhancing search experiences.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In embodiments of the present invention, a computing device accesses a webpage that is described by a webpage identifier, such as a Uniform Resource Locator (a “URL”). In addition to the content of the webpage, the computing device receives an image to display with the content. The image includes one or more selectable links. In embodiments of the present invention, the selectable links represent search queries that are based on the content of the webpage or the webpage identifier. In some cases, the selectable links include thumbnails associated with multimedia and/or multimedia queries. In some cases, the image include default selectable links, such as popular or verified links. Selection of one of the links causes the display of search results for one search query, in an embodiment.

### BRIEF DESCRIPTION OF THE SEVERAL DRAWINGS

The present invention is described in detail below with reference to the attached drawing figures, wherein:

FIG. 1 is a block diagram of an exemplary computing environment suitable for use in implementing embodiments of the present invention;

FIG. 2 is an illustrative display showing a user interface for use in accordance with an embodiment of the present invention;

FIG. 3 is a block diagram of an exemplary system in which embodiments of the present invention may be implemented;

FIG. 4 is an illustrative display showing an interface for use in accordance with an embodiment of the present invention;

FIG. 5 is an illustrative display showing an interface for use in accordance with an embodiment of the present invention;

FIG. 6 is an illustrative user interface displaying an image including selectable links for use in accordance with an embodiment of the present invention;

FIG. 7 is an illustrative user interface displaying an image including selectable links for use in accordance with an embodiment of the present invention;

FIG. 8 is an illustrative display showing exemplary search results in accordance with an embodiment of the present invention;

FIG. 9 is an illustrative user interface displaying an image including selectable links for use in accordance with an embodiment of the present invention;

FIG. 10 is an illustrative display showing exemplary search results in accordance with an embodiment of the present invention;

FIG. 11 is an illustrative user interface displaying an image including selectable links for use in accordance with an embodiment of the present invention;

FIG. 12 is an illustrative display showing exemplary search results in accordance with an embodiment of the present invention;

FIG. 13 is a flow diagram showing an exemplary method of determining queries in accordance with an embodiment of the present invention; and

FIG. 14 is a flow diagram showing an exemplary method of determining queries in accordance with an embodiment of the present invention.

### DETAILED DESCRIPTION

Embodiments of the present invention are capable of being used with, for example, embodiments of the invention disclosed in pending application Ser. No. 11/690,585, filed Mar. 23, 2007, the entirety of which is hereby incorporated by reference.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. In some cases, shorthand or commonly-used adjectives are used to describe components or features used in embodiments of the present invention. These descriptions are for clarity and ease of reference, and their use is not intended to imply functionality requirements, specifications, or limitations not discussed herein. Moreover, although the terms “step” and/or “block” may be used to connote different elements of methods employed, the terms should not be interpreted as implying any particular order among or between various steps herein disclosed unless and except when the order of individual steps is explicitly described.

The following figures and exemplary embodiments are intended to provide a general description of suitable computing environment(s) in which embodiments of the present invention may be implemented. Although not required, the invention will be described in the general context of computer-executable instructions, such as program modules or applications, being executed by computing devices, including personal computing devices and/or server devices. Generally, program modules include routines, programs, characters, components, data structures, etc., that perform particular tasks or implement particular instructions.

Other computer system configurations, including, for example, hand-held devices, multiprocessor systems, microprocessor-based or programmable consumer electronics, network PCs, minicomputers, and mainframe computers may be used. Embodiments of the present invention are capable of being practiced in distributed computing environments where tasks are performed by remote processing devices that are linked through communications network(s). Data and program modules may be located in both local and remote memory storage devices.

Throughout this disclosure, several acronyms and shorthand notations are used to aid the understanding of certain concepts pertaining to the associated system and services. These acronyms and shorthand notations are intended to help provide an easy methodology of communicating the ideas expressed herein and are not meant to limit the scope of the present invention. The following is a list of these acronyms:

| | |
|---|---|
| HTTP | Hypertext Transfer Protocol |
| SAS | Smart Advertising Service |
| SACIS | Smart Advertising Content-Independent Service |
| TLA | Top Level Aggregation |
| URI | Uniform Resource Identifier |
| URN | Uniform Resource Name |
| URL | Uniform Resource Locator |
| XML | Extensible Markup Language |

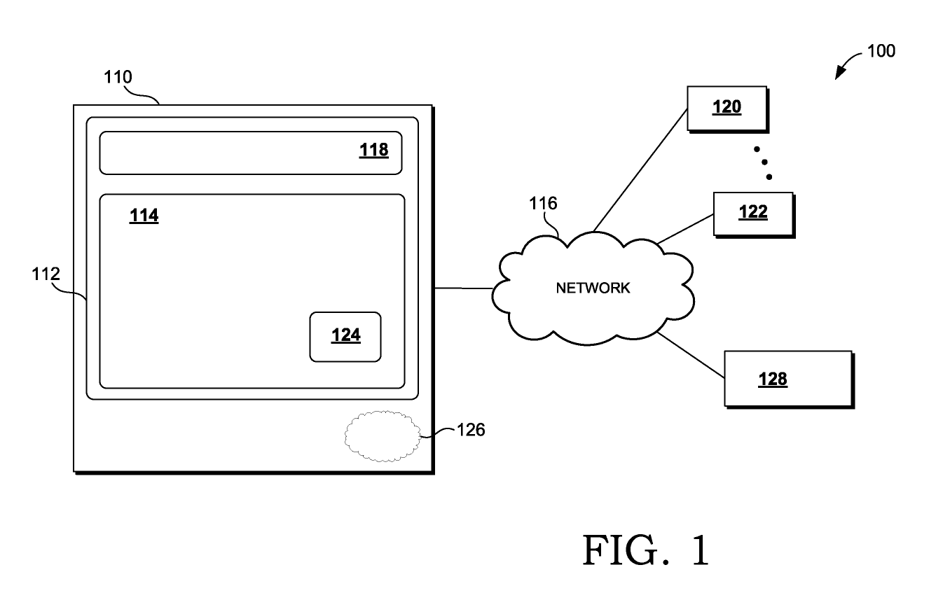

FIG. 1 illustrates a block diagram of an exemplary computing environment that is suitable for use with embodiments of the present invention, designated generally by reference numeral 100. The computing device 110 includes a user interface component 112. The computing environment 100 is but one example of a suitable computing environment and is not intended to suggest any limitation as to the scope of use or functionality of the invention. Nor should the computing device 110 be interpreted as having any dependency or requirement relating to any one or combination of components illustrated. The computing device 110, in embodiments, includes a bus that directly or indirectly couples to one or more memories, processors, presentation components, input/output ports or components, and/or power supplies.

In an embodiment, a method of embedding an image with contextual links is disclosed, including receiving a webpage identifier at a server. Items are extracted from the content of the webpage, including cached versions of the webpage, and query suggestions are identified based on the items. An image is provided, alongside the webpage content, that includes more than one link, and each link corresponds to a query suggestion. In another embodiment, a method of utilizing mapping data is disclosed, including recognizing a webpage that will be displayed on a user interface, and accessing the mapping data to determine a relationship between the webpage and potential, relevant search queries. One or more query suggestions is received and transmitted, in the form of a coding language, for conversion and display as an interactive advertisement on the webpage.

In yet another embodiment, a sponsored segment of a page, that is capable of directing search traffic, is provided. An exemplary method includes crawling content associated with a page, obtaining a keyword, and obtaining a search query suggestion based on the keyword. For example, search query suggestions are identified in a database that includes a mapping of keywords to potential search query suggestions, which may be based on prior, executed searches. The page, along with the sponsored segment, may be presented to a user, such that selecting a link within the sponsored segment causes the display of search results associated with the link.

The computing device 110 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that is used to encode desired information and be accessed by the computing device 110. Memory includes computer-storage media in the form of volatile and/or nonvolatile memory. The memory may be removable, nonremovable, or a combination thereof. Exemplary hardware devices include solid-state memory, hard drives, and optical-disc drives. In embodiments, the computing device 110 includes one or more processors that read data from various entities, such as memory.

The user interface component 112 in FIG. 1 shows exemplary, displayed content 114 that corresponds to a particular webpage or resource available through a network 116. An identifier of the webpage, or a location of a resource, may also be displayed. For example, the user interface component 112 includes an address bar 118 that is capable of displaying, or receiving as input, an identifier of a webpage. In some embodiments, the address bar 118 is not visible via the user interface component 112, but the identifier of the webpage may still be used to perform methods described herein.

The content 114 for a webpage may be obtained over the network 116 from one or more remote sources, such as remote sources 120, 122. Any number of remote sources may provide content 114 in conjunction or as separate, discrete sources. As discussed below, the content 114 is used to determine an advertising image 124 to display. In embodiments of the present invention, the computing device 110 accesses webpage content 114 using web browsing software 126. The computing device 110 receives content 114 along with the advertising image 124. As discussed in more detail below, in one example, an advertising image 124 includes selectable links for accessing search results from a search engine 128.

Although various blocks, devices and components are shown with lines for the sake of clarity, in reality, delineating various components is not so clear, and metaphorically, the lines would more accurately be gray and fuzzy. Therefore, the diagrams are merely illustrative of exemplary devices that are capable of use in connection with one or more embodiments of the present invention. Distinction is not made between such categories as “workstation,” “server,” “laptop,” “hand-held device,” etc., as all are contemplated within the scope of “computing device.” Similarly, the connections between components and devices may be physical, wireless, direct, or include one or more “hops” that are not illustrated. Multiple devices in the figures may actually be components of one physical device in practice, and one device may actually be distributed among more than one device.

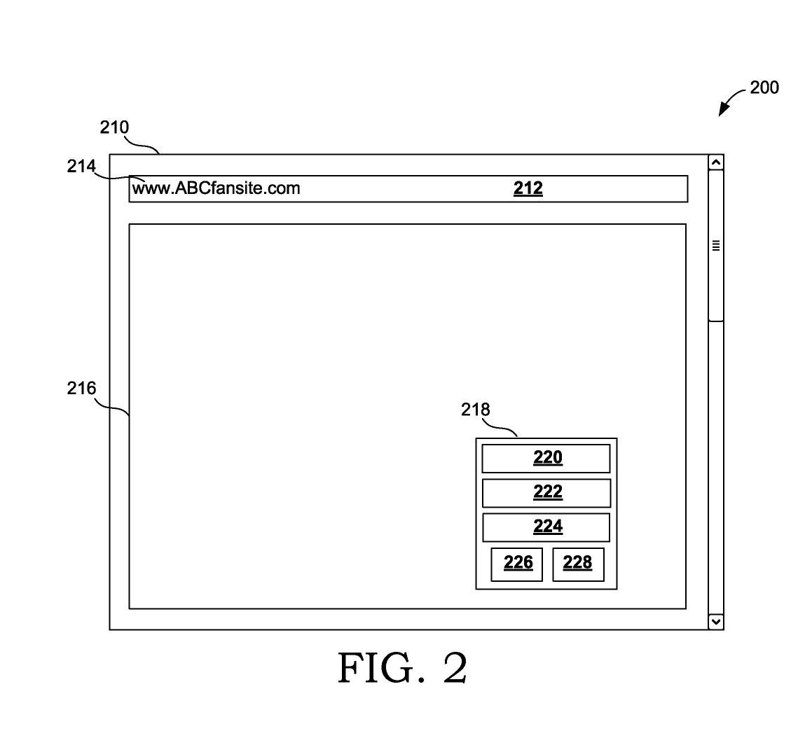

FIG. 2 is an illustrative display for use in accordance with an embodiment of the present invention, shown generally by numeral 200. The user interface 210 illustrated in FIG. 2 includes an address bar 212. The address bar 212 is an area that shows the webpage identifier 214 that corresponds to the webpage content 216 displayed on the user interface 210. In the specific example in FIG. 2, the webpage identifier 214 is “www.ABCfansite.com.” The address bar 212 may not be visible at all times. For example, an action may be required to access, or make visible, the address bar 212, in order to display the current webpage identifier 214. In some embodiments, the webpage identifier 214 is displayed or incorporated elsewhere on the page, or through a menu option, instead of through an address bar 212.

A webpage identifier 214 describes a source available over a network, such as network 116 in FIG. 1. Examples of a webpage identifier include a URL, a Uniform Resource Identifier (“URI”), a network address or location, or a webpage name used to retrieve or access content over a network, such as the Internet. A Uniform Resource Name (“URN”) may be used as a webpage identifier in embodiments. In some cases, where network searching has been broadened or supplemented by intranet or local device searching, the webpage identifier 214 is used to describe a local, cached version of a webpage, intranet pages, or a local document or file that is subject to searches on a network level. A webpage identifier 214 is displayed or input as descriptive text, such as a more general trade name or title, in some cases.

As shown in FIG. 2, the user interface 210 includes webpage content 216 and an advertising image 218 that is embedded next to the webpage content 216. In embodiments, the webpage content 216 surrounds the advertising image 218, while in other embodiments the advertising image 218 is in front of, or adjacent to, the content 216. The position or layer of the advertising image 218, with respect to other objects on the user interface 210, may be dynamic over time. For example, the advertising image 218 may appear larger for a predetermined amount of time after the advertising image 218 is loaded, then reduce in size or opaqueness. In another example, an advertising image 218 may change shape, size, placement, or appearance based on interaction with a cursor, mouse, or other selection device.

The advertising image 218, shown in the exemplary embodiment in FIG. 2, includes links 220 through 228. In one embodiment, the links 220, 222, and 224 are displayed as text that may be selected in order to view corresponding search results for the links 220, 222, and 224. One or more links, such as links 226 and 228, may be represented as thumbnail images, or multimedia links, for potential selection by a user. In embodiments, the links 220 through 228 are chosen for inclusion in the advertising image 218 based on the webpage content 216 of the currently-displayed webpage, and/or based on the webpage identifier 214.

An advertising image in accordance with embodiments of the present invention, such as advertising image 218, is displayed as a box, tile, or snippet that includes one or more options for selection. The image is not intended to be limited to paid advertisements or sponsored listings. A displayed image, or snippet, may be a mechanism for suggesting specific search queries. In embodiments, an interactive tile or portion of a webpage is used to improve or increase searching, or web-browsing, experiences.

For example, the advertising image 218 may include contextual-based links, such as related search queries, or default links. Flash snippets may be used as advertising images, and may be converted from Extensible Markup Language (“XML”) that is provided by one or more devices over a network, such as network 116 in FIG. 1. A snippet or interactive image may appear embedded on a web page, and may present textual links (e.g., 220, 222, 224) and/or links that are selectable thumbnails (e.g., 226, 228). Thumbnails, or multimedia links, may be any type of picture, image or video preview, including images compressed according to various standards, and links may represent options available for selection within an image or snippet. In an embodiment, the visual indication of a selectable link is only the change in the appearance of a cursor or pointing icon when hovered over the link.

Links within an image may be search queries suggested based on context. For example, displayed queries are based on words, images, objects, links, or other data or metadata, associated with the displayed webpage. Displayed queries may also be based on a webpage identifier 214. The links are determined using stored data in order to map content or identifiers to potential search queries, such that selecting a link leads to executing a search query and/or displaying search results generated by a search engine (e.g., search engine 128 in FIG. 1), in an embodiment.

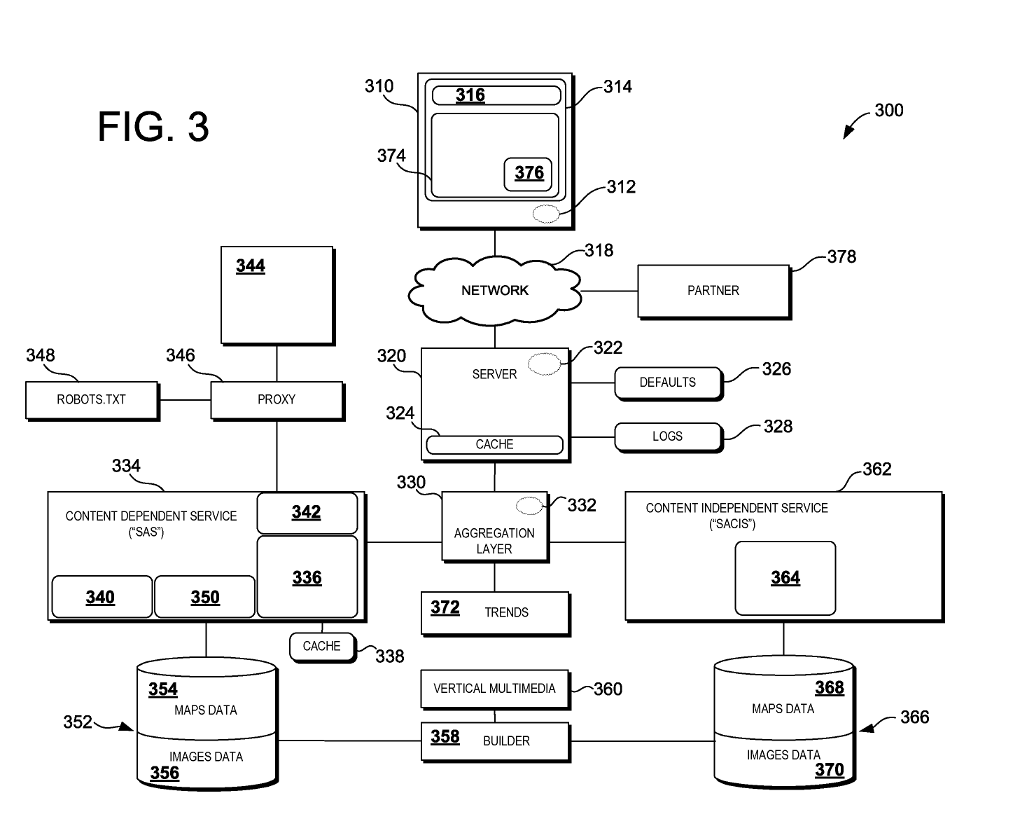

FIG. 3 is a block diagram of an exemplary computing environment in which embodiments of the present invention may be implemented, designated generally as 300. The computing device 310 in FIG. 3 corresponds to the computing device 110, shown in FIG. 1, and includes one or more software applications 312 for requesting and receiving information. The exemplary computing device 310 of FIG. 3 comprises an interface 314 that includes an address bar 316. In some cases, discussed below, a user inputs a network location into other types of command or input boxes. Embodiments of the present invention are not limited to instances where a location or identifier is displayed, directly entered or requested. In many cases, a particular webpage is reached through selecting a link or performing another action, such as activating content or opening electronic mail, that does not require manual input of webpage identifiers. Use of an address bar 316 or another input area is not necessary to communicate an identifier, such as a URL, over the network 318 to a server device 320.

Executable-instructions 322 and a cache 324 are used by the server device 320 in accordance with embodiments. The exemplary server device 320 is shown in communication with defaults 326 and logs 328, which may be remotely-accessible or incorporated into the server device 320. The server device 320 may be a front-end layer device capable of communicating with other devices or components and the computing device 310. The server device 320 is also shown in communication with an aggregation layer component 330, which is capable of using application 332 to coordinate or instruct communications from other devices or components, including a Smart Advertising Service component 334 (an “SAS component 334”). An example of an aggregation layer component 330 is a Top Level Aggregator, or TLA, component.

Prior to the crawling, or prior to the completion of crawling or processing of content, the server device 320 may use the cache 324 to generate or transmit an initial response. If a certain webpage identifier, such as a URL, has been provided with an interactive advertisement, the server device may use a version of the advertisement stored in the cache 324. In an embodiment, the server device 320 provides content from the cache 324 when it has not expired, based on the passage of time (e.g., a few minutes) or changes to a webpage.

In some cases, a normalization module 336 is used, in addition to a cache 338, to optimize embodiments of the present invention by reducing duplicative webpage content or search results, or by serving advertisements during the crawling process. For example, where links or terms lead to the same results, only one is presented to a user for selection, based on a comparison involving the cache 338. In some embodiments, the normalization module 336 or another module of the SAS component 334 enables domain “walking.”

Domain walking includes removing various ending portions of a web identifier and determining whether the cache 338 contains a match for a shortened, or higher-level, version of a web identifier. One or more modules of the modules discussed herein can be used to reduce response times associated with mapping or verifying cached data. For example, more matches may exist in the cache 338 when a truncated, or broader, version of a webpage identifier is compared to the cache 338. Domains may be walked in any “direction,” meaning content or identifiers from any hierarchal level associated with a webpage is accessed and used in embodiments, or, in some cases, only content or identifiers from a higher level, such a main page, are used.

In one specific example, an initial webpage identifier is “www.ABCfansite.com/photos/summer_tour.” A computing device may perform steps to examine the cache 338 for a match with “www.ABCfansite.com,” thus “walking” the domain in order to identify inexact matches. In embodiments, a preliminary advertising image is provided based on a cached advertisement associated with a truncated version of a webpage identifier (e.g., “www.ABCfansite.com”). A preliminary image may be used during the process of determining query suggestions for inclusion in a snippet on a webpage, or during or in lieu of default links displayed by the snippet. The cache 338 may contain relatively more matches for the identifier “www.ABCfansite.com” than it contains for the more specific, lower-level identifier, “www.ABCfansite.com/photos/summer_tour.”

The SAS component 334 in FIG. 3 communicates with a retrieve module 340, with or without a politeness module 342, to facilitate the crawling of pages. In an embodiment, the SAS component 334 obtains a webpage version 344 through a proxy 346, such as an HTTP proxy. The webpage version 344 may be obtained based on a webpage identifier, such as webpage identifier 214 in FIG. 2. Embodiments of the present invention obtain instructions 348, such as a “robots.txt” file shown in FIG. 3, for crawling a webpage version 344. In one example, a retrieve module 340 is used to obtain content, such as content included in the webpage version 344. The politeness module 342 is capable of guiding the crawling of content. As a specific example, the crawl-politeness module 342 of the SAS component 334 follows the instructions 348 to ensure “politeness,” such as crawling or ignoring certain content. This may be performed for increased relevance and/or privacy reasons.

The SAS component 334 further includes an extraction module 350 that is capable of extracting keywords, certain types of entities (proper nouns, brand names, newly-listed, etc.), objects, categories, phrases, or other portions of content. For example, when a link or address is entered that requests a corporation's home webpage, the name of the corporation and the name of a chief executive is extracted from the webpage content. In another example discussed below, a webpage for fans of a particular band, such as Band ABC, is crawled. Some examples of extracted items include the band leader's name, the fan club president's name, the band's screen name on social networking sites, the band's hometown, and the location of the band's upcoming concert.

The extraction module 350 is capable of targeting portions of content that are identified by webpage creators or administrators, such as titles or active links, or it may target items that are identified within search logs or other databases as items to be extracted during crawling. For example, prior search queries are stored or analyzed to obtain keywords or entities for extraction by the extraction module 350. The prior searches may be logged and analyzed, data mined or evaluated by one or more applications. The extraction module 350 extracts data from images, video, audio, and other multimedia data, or from text files associated with multimedia data, in embodiments.

As shown in FIG. 3, the extraction module 350 is capable of communicating with one or more storage components, shown as data store 352. The exemplary data store 352 includes a map storage module 354 and an images data storage module 356, which may be stored separately or together using one or more computing devices or storage media. The map storage module 354 is capable of communicating with the SAS component 334, specifically with the extraction module 350, in an embodiment. The data store 352 is configured to store, provide, or update a mapping of keywords (or other extractable entities or objects) to search query suggestions. The relationships may be stored in table format for look-up upon request. For example, extracted content may be communicated from the SAS component 334 to the data store 352, and matches, or related queries for the extracted content, may be communicated back to the SAS component 334.

Query suggestions include keywords, sets of words in any order or in a specified order, or other decipherable input for a search engine, such as search engine 128 in FIG. 1, including image or other multimedia data in some embodiments. For example, data, such as data in the data store 352 or other locations, may be analyzed for popular, effective, or safe query suggestions. In some cases, a click-through rate of the search results associated with a query is considered in order to select query suggestions. Other indications of the relevancy, success, or viewing time that corresponds to a query, or to search results associated with the query, are considered in embodiments. For example, an automated statistical analysis of relevancy or success factors may be used to influence or filter suggested queries. In an embodiment, the amount of data regarding one or more of these factors must reach a threshold amount (e.g., statistical significance) before a query is suggested.

An images data storage module 356 may be used to store, organize, or supply multimedia data, represented by images such as thumbnails. A builder component 358 is in communication with the images data storage module 356. For example, the builder component 358 obtains and/or transmits multimedia data from a multimedia vertical component 360. In an embodiment, the builder component 358 is active periodically (e.g., several times a week) and constructs relationships between objects, such as extracted entities and/or keywords, and multimedia images, including multimedia previews, clips, and samples. Multimedia data may be used to represent search parameters (i.e., queries for other related, multimedia results). In some embodiments, multimedia data is indicated or made available for previewing or sampling. For example, a selectable link may be used to search for multimedia previews, or the interactive advertising image may offer a multimedia preview within a webpage (e.g., as the selectable link).

The aggregation layer component 330 receives results from the SAS component 334, such as query suggestions and thumbnails, for presentation on the computing device 310, in embodiments. Additionally, in embodiments, a device such as the aggregation layer component 330 receives query suggestions and/or thumbnails from a Smart Advertising Content-Independent Service 362 (an “SACIS component 362”). In some cases, results from the SACIS component 362 are received or presented instead of results from the SAS component 334. In other cases, results from both components are presented together as selectable links within a snippet, such as advertising image 124 in FIG. 1.

The SACIS component 362 is capable of obtaining or determining query suggestions based on a webpage identifier, including a webpage name or a root portion of an identifier, or the displayed name of a link to a webpage. In embodiments, the SACIS component 362 is used to identify query suggestions for display in an interactive snippet or advertisement (e.g., advertising image 124). An SACIS component 362 may determine one or more search query suggestions, where the search queries, when executed, would return a currently-displayed webpage as a search result. Reverse- or inversion-type mapping, based on a webpage, may provide relevant search query suggestions that are displayed as selectable links within an embedded advertisement on the webpage, such as links 220 through 228 in FIG. 2. The suggestions may be ranked, filtered, or formatted for display within an interactive portion of a webpage.

One or more modules, such as normalization module 364, may be used to perform operations discussed above, such as normalizing webpage identifiers to reduce duplicate results or other inefficient links from appearing in interactive, embedded tiles. The normalization module 264, or another aspect of an SACIS component 362, is capable of implementing domain walking, as discussed above, in order to optimize, streamline, or increase response times. The SACIS component 362, as shown in the exemplary architecture in FIG. 3, is in communication with a data store 366. The various data stores, such as data stores 352 and 366, and cache 338, may share physical or virtual file space and may be incorporated into one or more other computing devices or components.

The data store 366, in embodiments, includes storage modules, such as a map storage module 368 and an images data storage module 370. The map storage module 368 that is associated with the SACIS component 362 may store mapping data, or relationship data, between webpage identifiers and search queries. The mapping data may be stored in table format for reference by applications. A reverse-type mapping (a “reverse-click” graph) is capable of determining relationships, including metadata, in the map storage module 368. In one example, offline search data is processed or mapped to determine search queries that, when executed, have returned a currently-displayed or requested webpage as a search result. This information may be stored or accessed using the map storage module 368.

As a specific example, the webpage identifier 214 in FIG. 1 (“www.ABCfansite.com”) is identified as a search result, or, in some cases, as a selected (“clicked on”) search result, that is associated with one or more queries. For example, “www.ABCfansite.com” is mapped to queries such as “Band ABC fan club United States” and “ABC Band on Social Networks.” Mapping may indicate that these queries are likely to return, or have returned in the past, a link to “www.ABCfansite.com” as a search result. In embodiments, an SACIS component 362 or other computing device obtains queries that have been mapped based on webpage identifiers, including any level of a domain name.

The data may be current search data, updated periodically, and/or based on offline logs of executed search queries. In some cases, the data includes information obtained after execution of the search queries, such as the actual selection of search results, the time spent viewing individual results, or other measures of success or relevance. In embodiments of the present invention, the SACIS component 362 uses data from the map storage module 368 to identify the suggested query of “ABC Band on Social Networks” when the URL “www.ABCfansite.com” is accessed. This suggested query may be one link within an advertising image, such as link 220 in FIG. 1.

One or more data store devices, such as the images data storage module 370 in FIG. 3, are in communication with the SACIS component 362. The images data storage module 370, as discussed above with respect to the images data storage module 356, may store or provide multimedia data, such as thumbnail images. In embodiments, an images data storage module 370 is used to add pictures, video clips or stills, or other audio-visual components to an advertising image. For example, links 226 and 228 in FIG. 2 are represented as thumbnail images. As discussed below, thumbnail images may direct users to multimedia search results, including similar pictures or multimedia that is displayed near query terms. The images data storage module 370 may receive multimedia, including thumbnail images, from the builder 358, which is shown in communication with a multimedia vertical component 360 in the exemplary embodiment in FIG. 3.

As shown in the example in FIG. 3, an aggregation layer component 330 is in communication with an SAS component 334, an SACIS component 362, and a trends component 372. As discussed, an SAS component 334 may be used to crawl webpage content, including metadata, and obtain query suggestions. An SACIS component 362 is used to obtain query suggestions based on, for example, a requested webpage. Query suggestions may be presented on a user interface as textual or multimedia links (e.g., user interface 210 with links 220 through 228 in FIG. 2). In general, content-dependent results from an SAS component 334 are prioritized over content-independent results from an SACIS component 362. In turn, results from the SACIS component 362 are prioritized over results from a trend component 372 and/or other default results, for example.

In some cases, a trends component 372 provides dynamic, or updated, query suggestions based on popularity, success (i.e., ultimate selection or viewing of search results), or other trends based on search data. A trend component 372 may compute scores in order to prioritize or select query suggestions, and the scores may be across categories of queries, such as music queries or sports queries. Query suggestions from the trends component 372 may be displayed as one or more selectable links within an interactive image, such as links 220 through 228 in FIG. 2. In embodiments, data or suggestions from the trends component 372 is used when no results, links, or query suggestions are provided by other components, such as an SAS component 334 and an SACIS component 362. In some cases, a trends component 372 is utilized while other results are pending, or to supplement results from other components.

The trends component 372 may be incorporated into one or more other components, in order to provide default or supplemental data at any stage or based on any terms identified during processing. In some embodiments, another set of defaults, including query suggestions, are provided in the absence of data from a trend component 372 or other components. This set of defaults are capable of directing traffic to a search engine by suggesting search queries in an interactive tile on a webpage. Default options may be obtained from a defaults component 326. In some cases, this set of defaults is analogous to data that may be obtained from a trend component 372. For example, the set of defaults includes query suggestions based on logged query data, such as frequent searches or click-through rates. In an embodiment, the set of defaults is used when the current, or dynamic, data from a trend component 372 is unavailable or unused. In some cases, defaults component 326 is able to provide preliminary, or permanent, default links to a server device 320 more quickly than one or more other components.

An exemplary webpage 374, with an exemplary interactive segment 376, is shown with respect to the computing device 310 in FIG. 3. As discussed below, the suggestions or links displayed by the interactive segment 376 are provided by components, such as an SAS component 334 or an SACIS component 362, over a network connection. An interactive segment 376 may include an advertising component, such as a java script component, that requests queries and/or multimedia images for display on webpage 374. Upon loading a webpage 374, an advertising java script component may contact the server device 320 that communicates with an aggregation layer module 332. A partner component 378 may communicate with devices over a network 318. The partner component 378 is capable of receiving requests to record advertising data, such as impressions, click-through rates, or viewing habits. In an embodiment, a log 328 is used to store or collect advertising data associated with an interactive segment 376 of a webpage.

The exemplary computing environment 300 is one example of a suitable computing environment that is not intended to suggest any limitation as to the scope of use or functionality of the invention. Embodiments of the invention should not be interpreted as having any dependency or requirement relating to any one, or more than one, of the components shown in the examples in the figures, such as FIG. 3. The exemplary networks 116 and 318, in FIGS. 1 and 3, respectively, may encompass or facilitate communication among any or all of the devices and components shown in FIGS. 1 and 3. Internet, intranet, or other wired or wireless communication links may be used to implement networks 116 and 318.

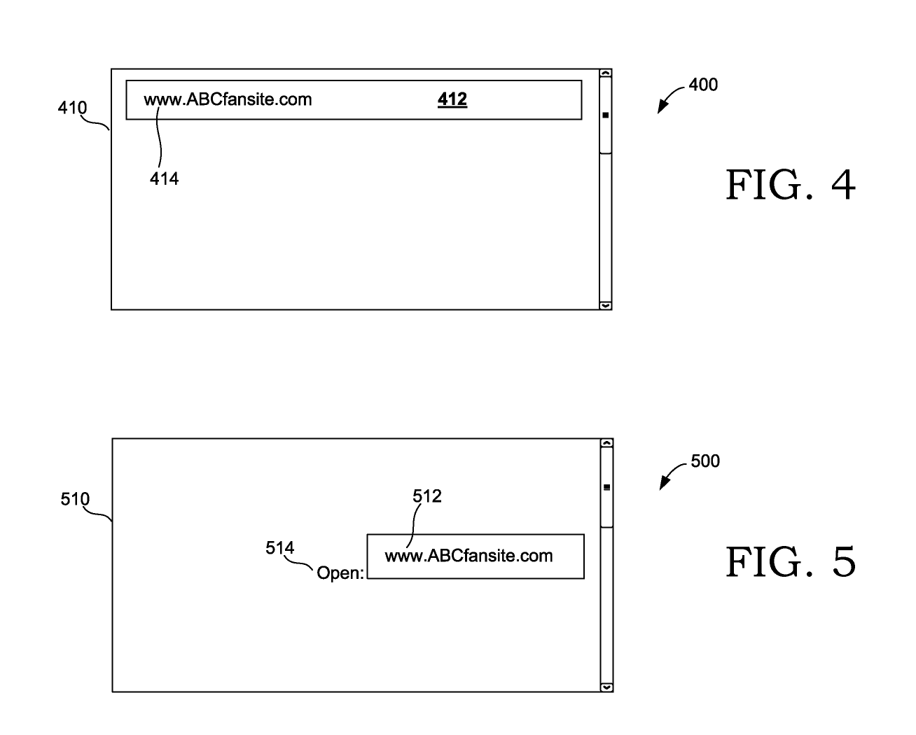

FIG. 4 is an illustrative display showing an interface for use in accordance with an embodiment of the present invention, designated generally by reference numeral 400. A user interface 410 is shown, including an input bar 412. The input bar 412 is part of an web browser window or other screen that enables an identifier, such as identifier 414, to be requested. In embodiments, a user directly inputs or selects an identifier 414 in an input bar 412. Users may also input or paste an abbreviation, an indication of a bookmark, or a keyword, in order to access or request a page that is identified by identifier 414. In one example, the identifier 414 is used by an SAS component 334 and/or an SACIS component 362 to obtain query suggestions for display on the page.

Turning to FIG. 5, an illustrative interface for use in accordance with an embodiment of the present invention is shown and designated generally as 500. A user interface 510 includes the webpage identifier 512, “www.ABCfansite.com.” The webpage identifier 512 is capable of being displayed as a link on an opened webpage. Alternatively, the webpage identifier 512 may be displayed as text that uses selection of a open option 514 in order to request or open the webpage. In some cases, user interface 510 is a separate view or menu screen used to open a webpage. In one example, an open option 514 is selected and an input area for the webpage identifier 512 becomes accessible. As discussed above, a webpage identifier 512 may be used by the SAS component 334 or the SACIS component 362 to provide query suggestions as selectable links on the webpage.

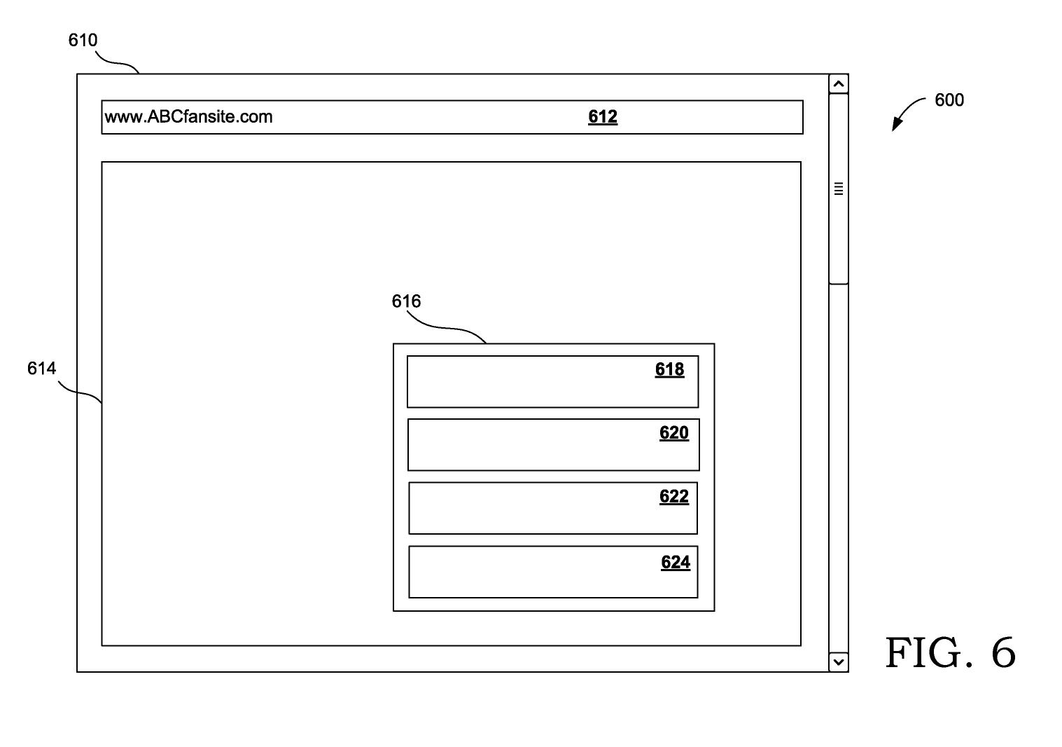

FIG. 6 is an illustrative display showing a user interface for use in accordance with an embodiment of the present invention, labeled generally as 600. The user interface 610 includes a current-page display area 612. In the exemplary embodiment in FIG. 6, the current-page display area 612 shows that the user interface 610 is currently displaying content 614 associated with the page “www.ABCfansite.com.” Content 614 may be provided by the entity responsible for the page “www.ABCfansite.com.” In some cases, content 614 is obtained from one or more proxies, caches or third-parties. Along with content 614, an interactive advertising image 616 is presented via user interface 610.

An advertising image 616 may include selectable links 618 through 624. Links 618 through 624, in embodiments, are search query suggestions that correspond to extracted objects from content 614. For example, an SAS component 334 determines keywords, images, etc., from content 614, including cached or proxy versions of content 614. These keywords or images may be mapped to query suggestions that are displayed as links 618 through 624. In some cases, when one of the links 618 through 624 is selected, corresponding search results that are generated by a search engine are displayed.

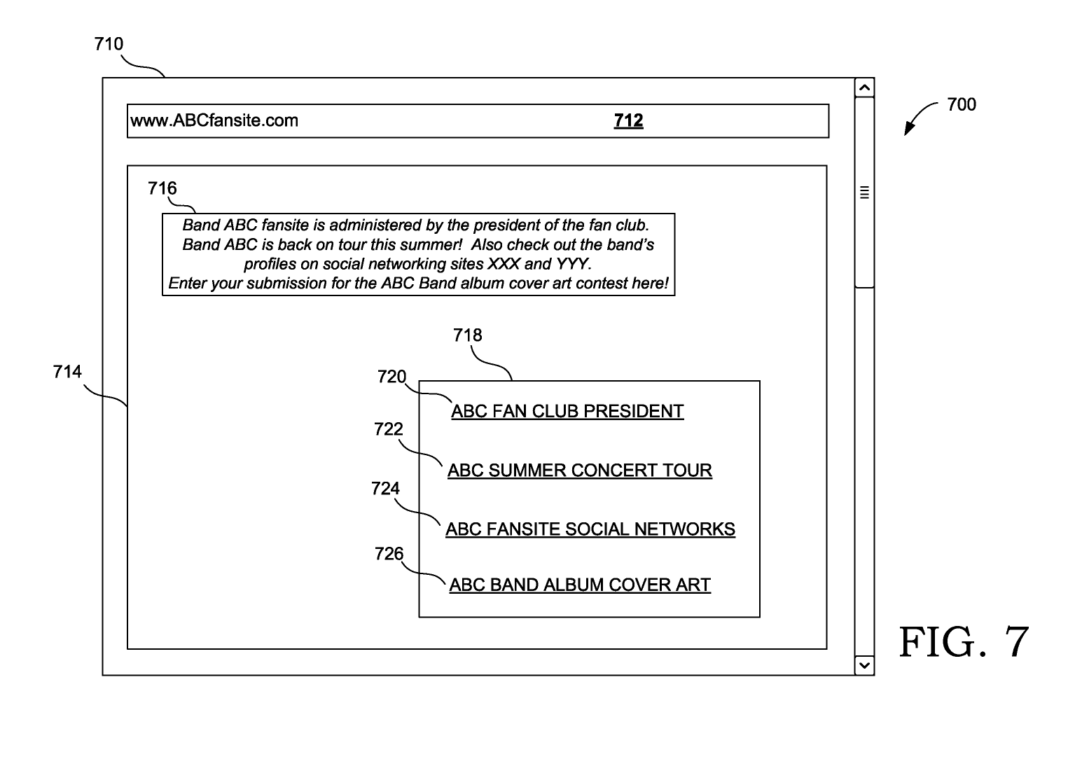

As shown in FIG. 7, and designated generally by numeral 700, an illustrative display includes an interface 710 that is used in accordance with embodiments of the present invention. As shown in a page-indicator area 712, the displayed page 714 is identified as “www.ABCfansite.com.” The displayed page 714, “www.ABCfansite.com,” includes content 716. The displayed page 714 also includes an interactive tile 718 that is used to advertise search queries 720 through 726.

In an embodiment, the content 716 is searched, crawled, and/or extracted in order to determine the advertised search queries 720 through 726 to display on page 714. In the specific embodiment shown, the content 716 includes keywords, such as “Band ABC”, “fan club president” or “president,” “cover art,” and “social networking.” An SAS component 334 may identify keywords, images, and other objects in the content 716, along with suggested search queries (e.g., links 720 through 726) based on the content 716. In embodiments, the SAS component 334 optimizes and supplements the queries. For example, multimedia links are presented by an interactive tile 718. In the exemplary embodiment in FIG. 7, the second link listed, link 722, is a suggested query for “ABC Summer Concert Tour.” In embodiments, an SACIS component 362 uses the displayed page 714 to determine related search queries for display as links 720 through 726. In some cases, trending defaults and/or static defaults are used as one or more of links 720 through 726.

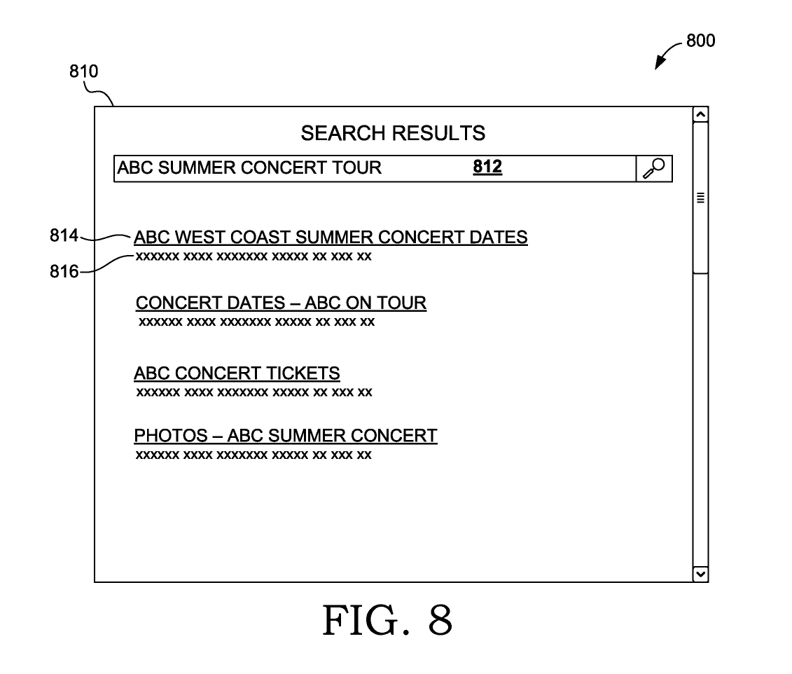

Turning to FIG. 8 is an illustrative display 800 shows exemplary search results in accordance with an embodiment of the present invention. In one example, the user interface 810 includes a search box 812, indicating that the query “ABC Summer Concert Tour” was executed and that search results 814 were generated in response. The query “ABC Summer Concert Tour” may be executed in response to selection of a link, such as link 722 in FIG. 7. Search results 814 may be provided, directly or through a proxy or cache, by a search engine, such as the search engine 128 in FIG. 1.

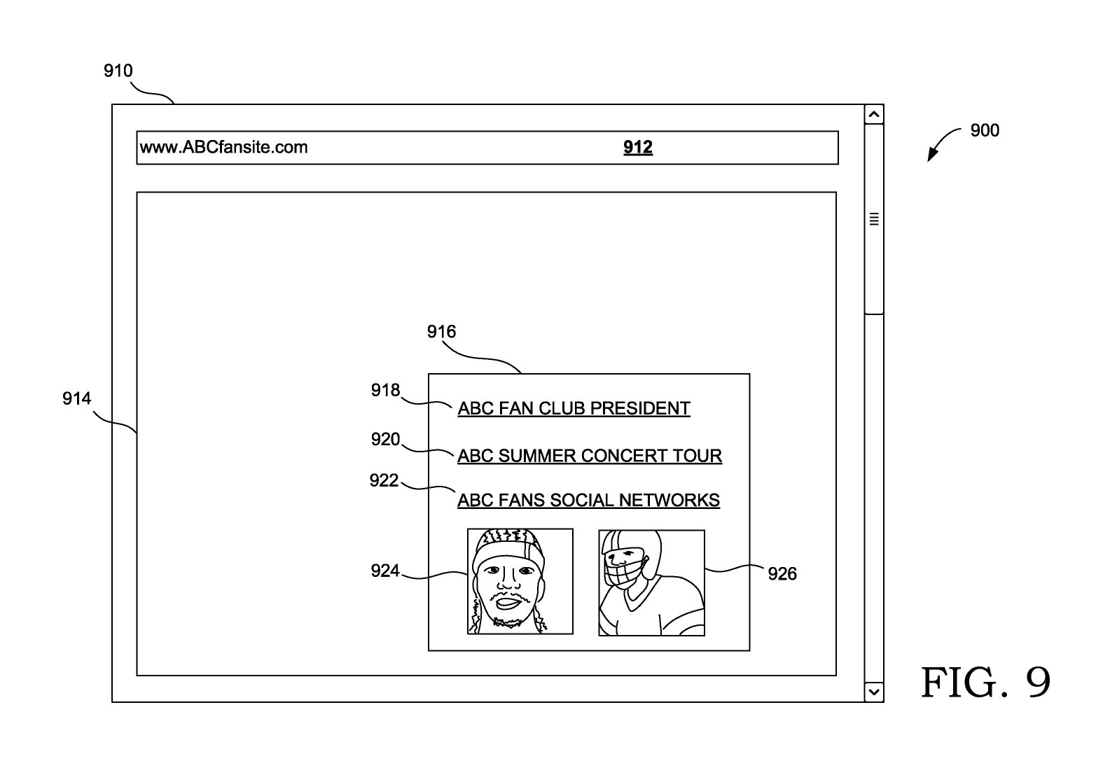

FIG. 9 is an illustrative display, designated generally by reference numeral 900, showing a user interface 910 for use in accordance with an embodiment of the present invention. The page-identifier 912 indicates that the page “www.ABCfansite.com,” including content 914. As shown in FIG. 9, an example of an interactive image 916, such as a flash format snippet that includes options for selection, is embedded in content 914. A server device (e.g. server 320), or other computing device in communication with a network, may supply data in the form of XML code that is converted to an interactive image, such as a snippet. The data may include query suggestions from one or more components, such as SAS component 334 and/or SACIS component 362. Specifically, links 918, 920, and 922 are query suggestions from one or more mapping functions, or from data bases including default suggestions, such as dynamic default suggestions, in an embodiment.

Pictures 924 and 926, shown within the interactive image 916 in FIG. 9, are selectable links, or, in some embodiments, the pictures 924 and 926 are supplied to visually enhance the interactive image 916 or to provide context without linking to additional, or unique, content. For example, in FIG. 9, a picture 924 corresponds to one of the other links (link 918), which is a query for “ABC Fan Club President.” In embodiments, this allows the interactive image 916 to provide more than one option for selecting a query for the fan club president, through a textual link 918 or a picture 924. A multimedia vertical component 360, as used by an advertisement builder component 358, facilitates supplying data that results in displayed pictures 924 and 926. In embodiments, pictures 924 and 926 are thumbnail images or other compressed photos or video stills used for display.

In some cases, pictures 924 and 926 are links that lead to similar pictures, or pictures of the same subject matter, from the same source, or with similar digital rights, restrictions, or management/ownership. In some cases, pictures 924 and 926 correspond to suggested queries, and selection of either picture will display search results, in the form of textual links, additional multimedia, or a combination. The suggested queries represented by images, such as thumbnail images, may be based on queries identified by an SAS component 334 or an SACIS component 362. In embodiments, a query represented by an image corresponds to terms or source content used to describe the image. For example, thumbnails or other multimedia previews are displayed as links and used to request multimedia based on a similar name, images, keywords or other related content on pages.

In an embodiment, an entity is extracted from content 914, such as a keyword or specific name, including a company or individual person, or a category (e.g., “professional basketball player”). In some cases, the content used for extraction is not currently-displayed content 914, but content available thought domain walking and/or proxy or cache devices. For example, the page “www.ABCfansite.com,” including content 914, are currently displayed in an embodiment illustrated in FIG. 9. Domain walking, and other versions of the page, may be used to identify content that is not currently displayed. For example, a message board that is part of an ABCfansite domain may include discussions regarding professional basketball players. This content may be crawled, extracted, and/or communicated to a data store 352, in order to include a picture 924 of a professional basketball player as a link on the page “www.ABCfansite.com.” In embodiments, the selection of a picture 924 causes the execution of a search query with additional pictures, or a combination of text and multimedia content, as search results.

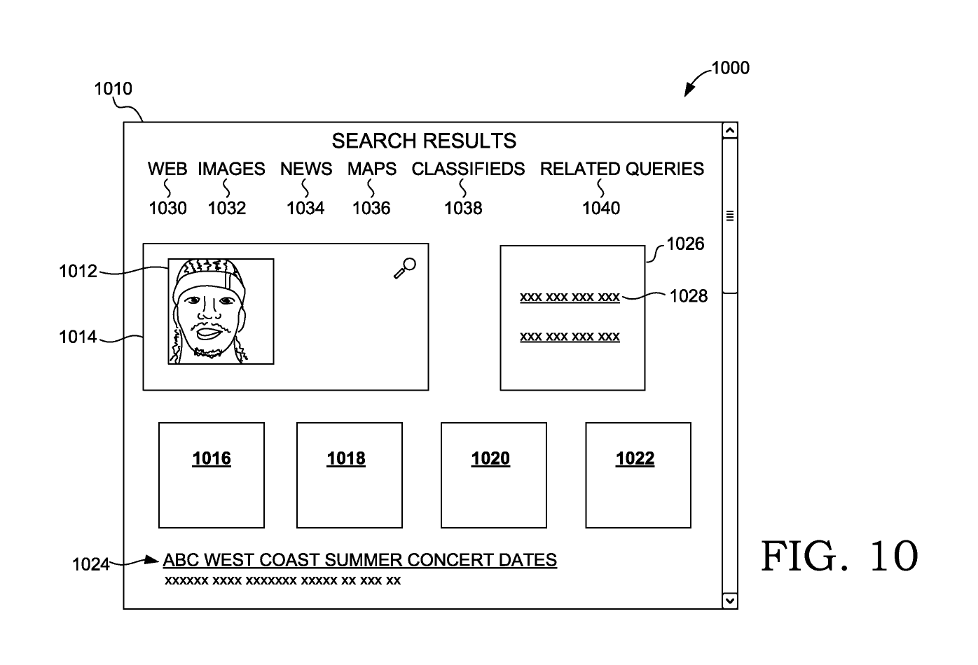

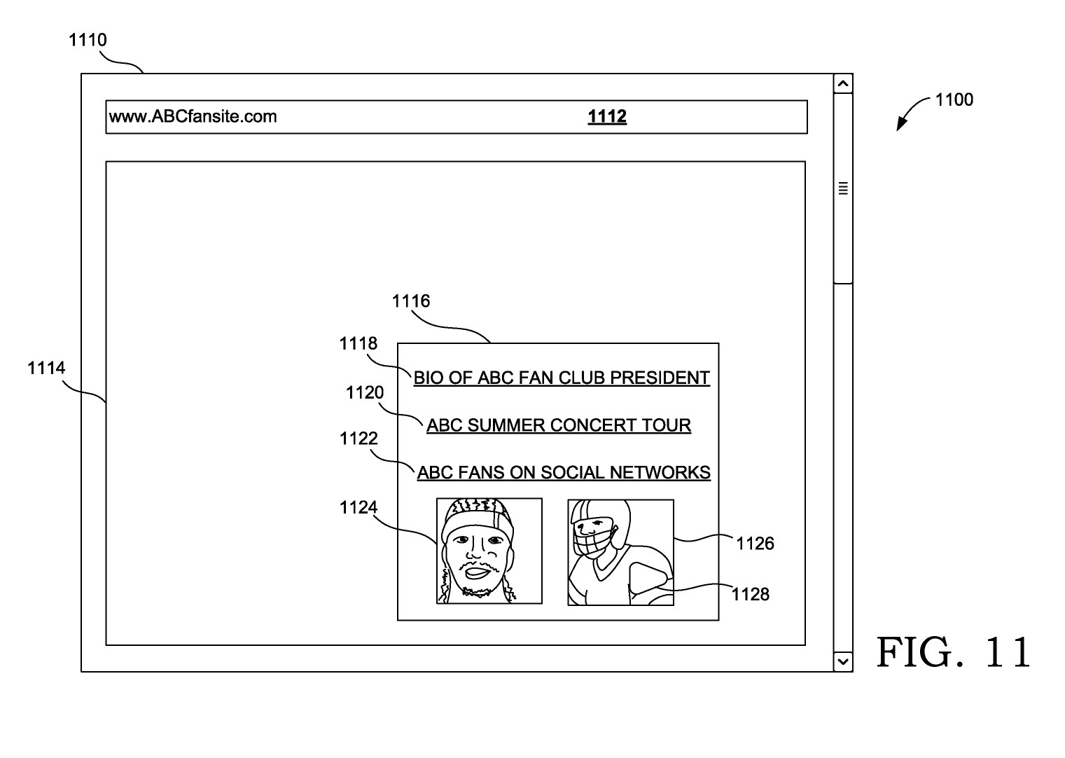

FIG. 10 is an illustrative display, designated generally as 1000, showing exemplary search results in accordance with an embodiment of the present invention. The user interface 1010 shows search results based on a selection of a picture 1012 as a link. For example, in FIG. 9, picture 924 is selected as a link. The display 1000 shown in FIG. 10 may be shown in response to the selection of picture 924 (shown as 1012 in FIG. 10), as executed search results. Picture 1012 may be displayed as a thumbnail image in either figure, and picture 1012 may be displayed within a search box 1014 on the search results page.

As shown in FIG. 10, search results 1016 through 1022 are additional images or previews. Search result 1024 is shown as a hyperlink. Display 1000 includes an advertising image 1026, with one or more selectable links 1028. Advertising image 1026 is an interactive portion of the search results webpage that is used, through selection of a link 1028, to execute a search query suggestion. A link 1028 is displayed as text representing the actual search terms, a euphemism, or a multimedia link, such as a selectable image or audio/video preview. In one specific example, a flash format snippet is used (as advertising image 1026) on a search results page to provide options for executing additional, or different, search queries.

The display 1000 in FIG. 10 illustrates search results 1016 through 1024 along with optional search options 1030 through 1040. The search options include links or preference settings that allow searches to be converted web results (search option 1030), images results (search option 1032), news results (search option 1034), maps results (search option 1036), classifieds results (search option 1038) including online merchants and auction or retail pages, and related queries (search option 1040). Search options 1030 through 1040 enable a direct, single-click conversion from one type of search results to another, in embodiments, including potentially broader or narrower related queries. In one example, picture 1012 shows the president of a fan club for Band ABC, and selection of this picture 1012 yields search results that include link 1024 to upcoming concerts for Band ABC.

FIG. 11 is an illustrative display, labeled generally by numeral 1100, showing a user interface 1110 for use in accordance with an embodiment of the present invention. An address bar 1112 indicates the displayed page, including content 1114. As described above, an SAS component 334 and/or an SACIS component 362 may be used to generate interactive tile 1116. Specifically, the components (334, 362) may be used to determine interactive links 1118 through 1126. In embodiments, one or more links 1118 through 1126 is supplied as a default that represents a popular or otherwise suggested query. As shown in FIG. 11, link 1126 includes a multimedia indicator 1128 (for example, a “play” button indicating video). Other features, such as a posted length (minutes/seconds), label, or source (video page), are used to indicate multimedia in some cases.

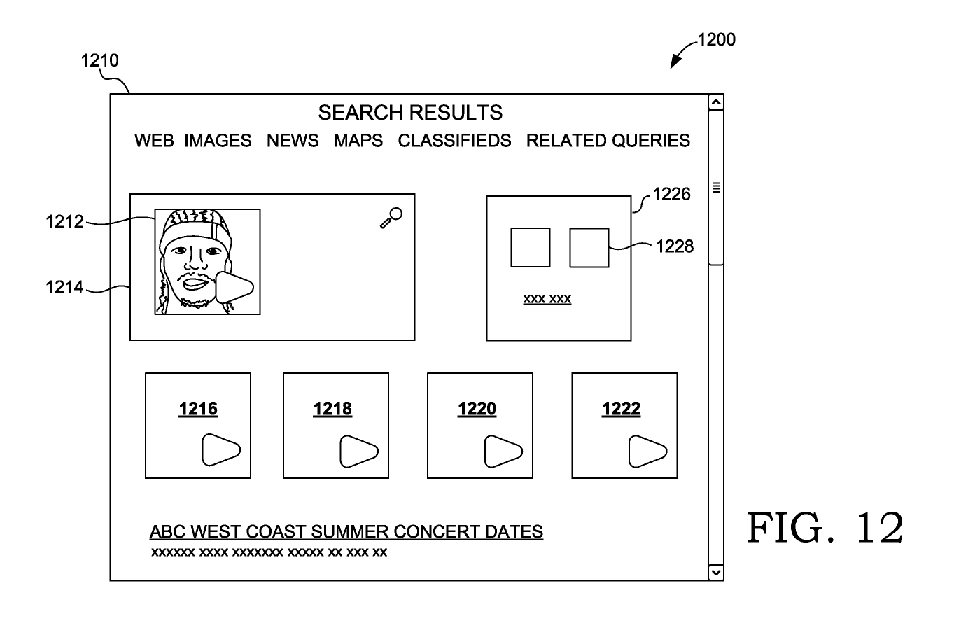

FIG. 12 is an illustrative display, designated generally as 1200, showing exemplary search results in accordance with an embodiment of the present invention. The display 1200, in one example, shows a user interface 1210 with search results that correspond to a search based on, or a selection of, the link 1126 shown in FIG. 11. The link 1126 from FIG. 11 is shown in FIG. 12 as multimedia image 1212 in search area 1214. Additional multimedia images 1216 through 1222 are search results based on multimedia image 1212. An interactive segment 1226 of user interface 1210 includes one or more selectable links 1228, such that selection of one of the selectable links 1228 generates additional, or new, search results. In some cases, results are from a separate search engine or application than the one employed to generate display 1200. In one example, link 1228 is selectable in order to view pictures, instead of video, thereby adjusting the relevancy and/or the format of the search results.

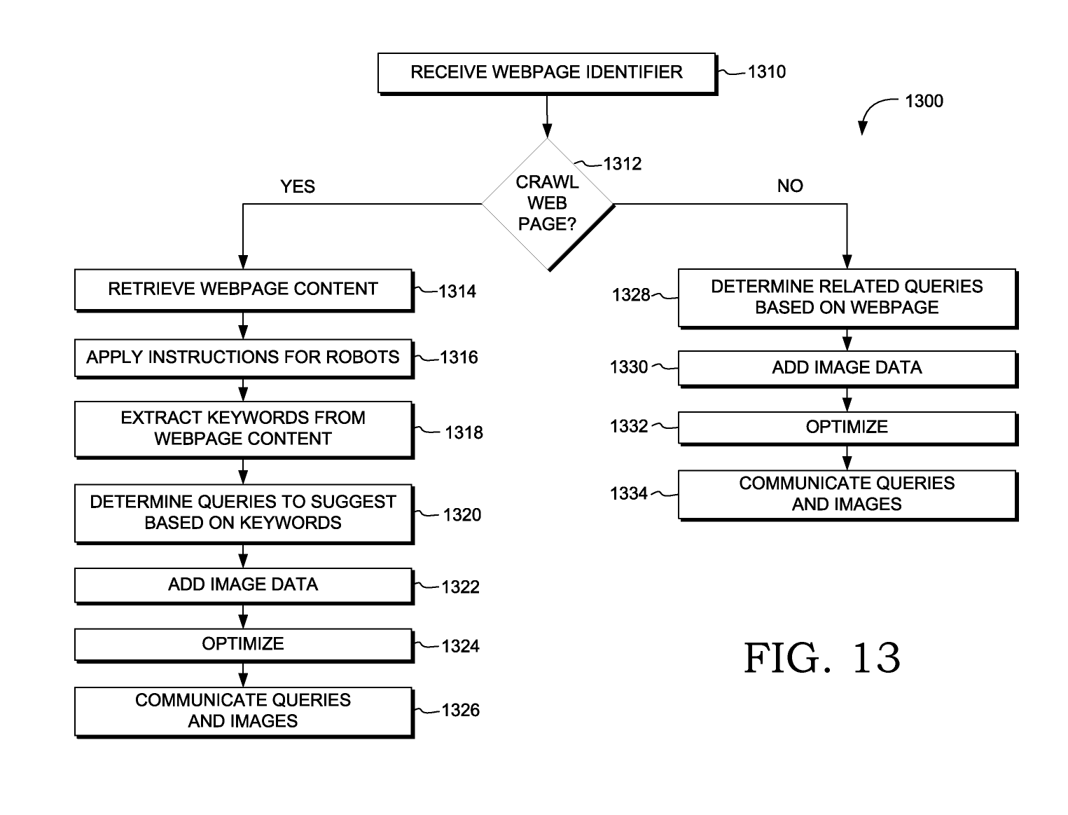

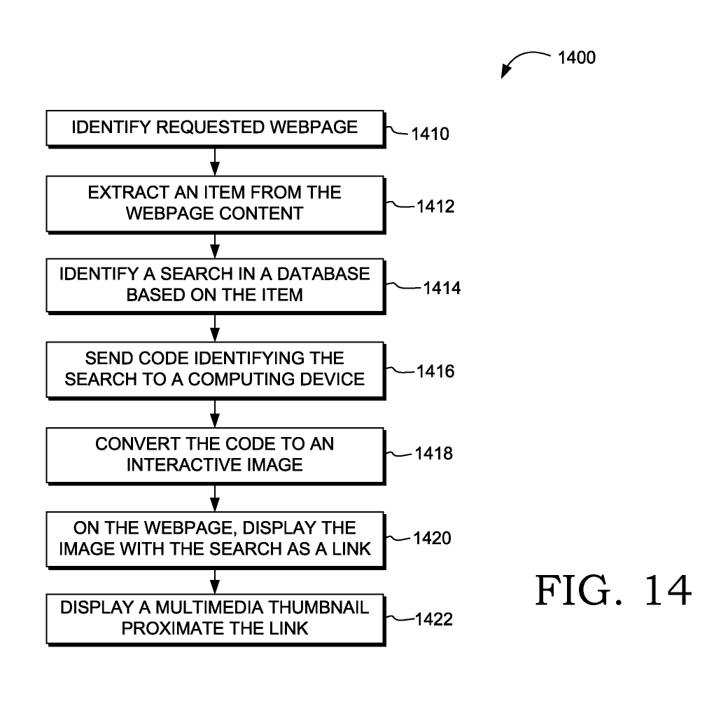

FIG. 13 shows a flow diagram, designated generally as 1300, illustrating an exemplary method of accordance with an embodiment of the present invention. As shown at step 1310, a webpage identifier is received by, for example, a computing device such as server device 320 in FIG. 3. At step 1312, it is determined whether or not a webpage that corresponds to the webpage identifier will be crawled. The webpage that corresponds to an identifier may be a proxy version of a page, a cached version of a page, or another copy that provides access to webpage content.

In some embodiments, a webpage that corresponds to the webpage identifier is actually a webpage that shares a root portion of an identifier with the identifier received at step 1310. For example, with respect to the identifier “www.ABCfansite.com/photos/summer_tour,” the URI “ABCfansite.com” (or content from ABCfansite.com) is used as an identifier or keyword in accordance with embodiments of the present invention. Similarly, the identifier “www.ABCfansite.com/photos/winter_tour” is used in association with the identifier “www.ABCfansite.com/photos/summer_tour” by embodiments, by using, for example, domain walking that reaches identifiers or content at additional levels or with similar main, or root, identifiers or content. At step 1312, if a version of the webpage, or a related webpage via a shared domain portion, is available to crawl, then “Yes” is selected. At step 1314, said webpage or related webpage is retrieved.

As shown at step 1316, instructions for crawling content are considered, or adhered to, when accessing the content. In one example, a robots.txt file or component, such as instructions 348 in FIG. 3, is applied in order to avoid irrelevant or private material (as indicated by the page itself, in this example). Keywords, including entities such as people, corporations, events, proper nouns, and linked terms, frequent terms, popular search terms, or terms indicated by metadata or coding techniques as relevant, may be extracted from content in step 1318. A certain number of keywords, or a certain amount of keywords with matches, may be extracted before the crawling is terminated, or a time limit may expire.

Step 1320 indicates that one or more potential search queries are determined, based on extracted keyword(s). For example, as shown in FIG. 7, the search query suggestion shown as link 720 (“ABC Fan Club President”) is identified, selected, or ranked as link based on keywords from content 716. The content 716 shown in FIG. 7 may have been crawled as a version from a proxy source (e.g., proxy 346) and the phrase “the president of the fan club” may have been extracted and mapped to the query suggestion shown as link 720.

Continuing with FIG. 13, step 1322 shows adding image data, such as thumbnail images, including multimedia links and/or previews or stills. As discussed above and shown in FIG. 3, an exemplary multimedia vertical component 360 is used, in combination with an advertising builder component 358, to provide image data to the components or computing devices that deliver code to be displayed on a computing device 310. Thumbnail images or other compressed images, used as links or to supplement links, may be directly mapped to corresponding entities or subjects. For example, for a proper noun, a single vertical relationship may exist between the noun and a thumbnail image, made available to data stores 352 and/or 366, for display within in an interactive advertisement.

Step 1324 indicates that the results, which may be query suggestions and/or pictures that are displayed as links, are optimized in an embodiment. For example, duplicative links, or links that direct to duplicative sources or content, may be filtered. Domain walking may be utilized in order to optimize or streamline results. In embodiments, certain one or more links, where previous users did not view the link for a predetermined threshold amount of time, according to a log of search query data, are filtered.

Specifically, in one example, if a particular search query, when used historically, yielded search result pages that were viewed for less than a minimum amount of time, then the query may be filtered from use in an interactive advertisement. In some cases, unverified, unsecured, or other questionable query suggestions (or results) are filtered. If a computing device (e.g. computing device 310) has limited display or screen properties (for example, a small screen size or restricted graphics capabilities), then certain queries or multimedia images may be filtered. As shown at step 1326, one or more suggested queries, and any multimedia images, are communicated for presentation. In one example, a server device 320 transmits XML code, using a network 318, for display in flash format.

Returning to step 1312, if a version of a webpage is not available to crawl, or not instructed to be crawled, the related queries may be determined based on the webpage (step 1328). For example, queries may be suggested that have led to the webpage during prior searches, according to offline logs of executed queries, in an embodiment. Domain walking may be implemented in order to determine inverse, or reverse, query suggestions for an identifier, such as a URL. One or more data storage devices may be analyzed for relationships among identifiers and query suggestions.

The query suggestions may be presented as selectable links within a sponsored portion of a webpage, thereby directing search traffic to a search engine, such as search engine 128, that may display search results upon selection of a link (i.e., upon execution of the suggested query). As with step 1322, relevant image data is added at step 1330. For example, multimedia pictures or previews are used to supplement, or represent, suggested queries from an SACIS component 362. At step 1334, the identified queries and images are communicated for presentation in an interactive advertisement format, such as a flash snippet.

Turning to FIG. 14, a flow diagram, labeled generally by numeral 1400, shows an exemplary method in accordance with an embodiment of the present invention. As shown in FIG. 14, a webpage is input, selected, or loaded via a user interface, and the webpage is identified in step 1410. In step 1412, an item is extracted from webpage content. In one specific embodiment, a version of the webpage is obtained from a proxy component and crawled, according to the applicable robots.txt file, in order to find content that may be mapped to suggested queries and/or thumbnail images. One or more databases (e.g., data store 352) may be used to locate search queries that are related to the content (step 1414). Computing code that represents the related search queries is sent to a computing device in step 1416, where it is converted to an interactive advertising image in step 1418.

As shown at step 1420, the advertising image is displayed along with the webpage, in the form of an embedded tile, a pop-up advertisement, or other display forms, such as dynamic shapes, used in conjunction with a webpage. At step 1422, a multimedia thumbnail, such as a compressed picture, is presented near the one or more links that correspond to searches, The multimedia thumbnail may indicate image data, or other forms of media in a still or preview state. In some embodiments, a multimedia thumbnail is selectable to execute a search or display results, such as related pictures.

The present invention has been described in relation to particular embodiments, which are intended in all respects to be illustrative rather than restrictive. Alternative embodiments will become apparent to those of ordinary skill in the art to which the present invention pertains without departing from its scope. From the foregoing, it will be seen that this invention is one adapted to attain ends and objects set forth above, together with other advantages which are inherent to the system and method. It will be understood that certain features and subcombinations are of utility and may be employed without reference to other features and subcombinations. This is contemplated by and is within the scope of the claims.

What is claimed is:

1. Computer-readable media having computer-executable instructions embodied thereon that, when executed, perform a method of providing an interactive image, the method comprising:
receiving a webpage identifier at a server device, wherein the webpage identifier corresponds to a webpage that includes content;
extracting at least one item from the content;
identifying at least one query suggestion based on the at least one item; and
providing an image, wherein the image and the webpage are displayed simultaneously, and wherein the image includes at least one link that corresponds to the at least one query suggestion.

2. The computer-readable media of claim 1, wherein extracting the at least one item includes crawling the content for keywords.

3. The computer-readable media of claim 1, wherein extracting the at least one item includes crawling the content for an item selected from the group of: a metadata item, a graphic item, and a link item.

4. The computer-readable media of claim 1, wherein the image includes a set of links including more than one link, and wherein each link of the set corresponds to a unique query suggestion.

5. The computer-readable media of claim 1, wherein the server device transmits the image using an extensible markup language.

6. The computer-readable media of claim 1, wherein the image includes a set of links including more than one link, and wherein a first link is represented as a picture.

7. The computer-readable media of claim 6, wherein the picture is a compressed picture that is selectable to submit a request to view additional pictures.

8. The computer-readable media of claim 6, wherein the picture is a multimedia link that is selectable to view additional multimedia links.

9. The computer-readable media of claim 1, wherein the image includes a set of links including more than one link, wherein the at least one item is a proper noun, and wherein a first link of the set is represented by a picture that corresponds to the proper noun.

10. Computer-readable media having computer-executable instructions embodied thereon that, when executed, perform a method of utilizing mapping data to suggest searches, the method comprising:
identifying a first page for display on a interface;
accessing mapping data that indicates a relationship between the first page and one or more queries;
receiving the one or more queries at a computing device; and
transmitting code to a second computing device, where the code is used to display the one or more queries as options for selection.

11. The computer-readable media of claim 10, wherein the one or more queries are displayed as one or more selectable links, wherein the one or more selectable links are presented via an embedded snippet in the first page.

12. The computer-readable media of claim 10, wherein the one or more queries are previously executed search queries.

13. The computer-readable media of claim 10, wherein the one or more queries are filtered by the computing device.

14. The computer-readable media of claim 10, further comprising receiving image data at the computing device.

15. The computer-readable media of claim 14, wherein the image data is used to display a compressed image near the one or more queries.

16. The computer-readable media of claim 15, wherein the compressed image represents one of the one or more search queries, such that a selection of the compressed image will execute the one search query of the one or more search queries.

17. The computer-readable media of claim 10, further comprising:
identifying a cached version of data used with the first page; and
determining that the cached version of the data is insufficient.

18. The computer-readable media of claim 10, further comprising:
receiving impression data; and
logging the impression data.

19. Computer-readable media having computer-executable instructions embodied thereon that, when executed, perform a method of providing a sponsored segment of a page that is capable of directing search engine traffic, the method comprising:
crawling content associated with a page;
obtaining a keyword from the content;
obtaining a search query suggestion based on the keyword, wherein the search query suggestion is obtained from a database that includes a mapping of one or more keywords to one or more search query suggestions;
obtaining an image based on the keyword, wherein the image is associated with multimedia content;
presenting the page including a sponsored segment of the page, wherein the sponsored segment presents the search query suggestion and the image associated with multimedia content; and
receiving a selection of the search query suggestion by a computing device, wherein the selection causes the display of a set of search results associated with the search query suggestion.

20. The computer-readable media of claim 10, wherein the image is selectable to cause the display of related images.
